(19) United States
(12) Patent Application Publication
(10) Pub. No.: US 2013/0173254 A1
(43) Pub. Date: Jul. 4, 2013

(54) Sentiment Analyzer

(71) Applicant: Farrokh Alemi, McLean, VA (US)

(72) Inventor: Farrokh Alemi, McLean, VA (US)

(21) Appl. No.: 13/726,059

(22) Filed: Dec. 22, 2012

Related U.S. Application Data
(60) Provisional application No. 61/582,255, filed on Dec. 31, 2011.

(51) Int. Cl. G06F 17/28

(52) U.S. Cl. CPC G06F 17/28
USPC 704/9

(57) ABSTRACT

A sentiment analysis tool receives a t-gram from an electronic device. The t-gram comprises gram(s), each of the gram(s) representing a word in a collection of words. A polarity is set for the t-gram. Possible smaller-gram combinations are generated from the t-gram. Until a condition is met, iterative actions are taken. A likelihood ratio is calculated for the largest of the smaller-gram combinations employing the training set. A determination is made of whether the likelihood ratio meets a minimum replication threshold. If satisfied: the smaller-gram combinations most distant from an undefined polarity value are selected, the smaller-gram combinations employed in calculating the likelihood ratio are excluded; the polarity value for the t-gram is increasing proportional to the likelihood ratio; and the training set is reduced to v-grams that include the t-gram. Otherwise, the size of the smaller-gram is reduced by 1.

### CROSS-REFERENCE TO RELATED APPLICATIONS

This application claims the benefit of U.S. Provisional Application No. 61/58255, filed Jan. 3, 2012, which is hereby incorporated by reference in its entirety.

### BRIEF DESCRIPTION OF THE SEVERAL VIEWS OF THE DRAWINGS

FIG. 1 is an example block diagram showing real time monitoring of clinicians as per an aspect of an embodiment of the present invention.

FIG. 2 is an example illustration of a display as per an aspect of an embodiment of the present invention.

FIG. 3 is an example illustration of a user interface as per an aspect of an embodiment of the present invention.

FIG. 4 is an example flow diagram showing the establishment of the polarity of text as per an aspect of an embodiment of the present invention.

FIG. 5 is an example flow diagram showing the assessment of a minimum number of replications as per an aspect of an embodiment of the present invention.

FIG. 6 is an example flow diagram as per an aspect of an embodiment of the present invention.

FIG. 7 is an example diagram illustrating how both the length and width of the training data set may matter in analyzing text as per an aspect of an embodiment of the present invention.

FIGS. 8A-8B are example table showing the prevalence of word combinations in an example training set employed by an aspect of an embodiment of the present invention.

FIG. 9 is example table showing a numerical example for the calculation an example phrase employing an aspect of an embodiment of the present invention.

FIG. 10 is a table showing the prevalence of word combinations in an example training set employed by an aspect of an embodiment of the present invention.

FIG. 11 is a table showing the prevalence of word combinations in different cases for an example training set employed by an aspect of an embodiment of the present invention.

FIG. 12 is a table showing the Maximum Likelihood Ratio Given the Marginal Probabilities in an example training set employed by an aspect of an embodiment of the present invention.

FIG. 13 is a table showing calculations for a likelihood ratio of zero employing an example training set employed by an aspect of an embodiment of the present invention.

FIG. 14 is a table showing calculations for a likelihood ratio of zero employing an example training set employed by an aspect of an embodiment of the present invention.

FIG. 15 is a flow diagram of an aspect of an embodiment of the present invention.

FIG. 16 is a block diagram of a computing environment in which aspects of embodiments of the present invention may be practiced.

### DETAILED DESCRIPTION OF EMBODIMENTS

Embodiments of the present invention provide for (a) identifying, extracting and assessing the polarity of word combinations from a training database; (b) using this information to understand the contextual of use of a word; and (c) using context dependent words to classify text. The embodiments employ computing machines to combine statistical and case-based learning to classify the polarity of word text by either the frequency of occurrence of the word combination and/or by a single instance of rare word combinations. In one embodiment, customer comments may be classified into complaint/praise and classifies the complaints further into various types. In another embodiment, the time period or number of intervening events till the next negative polarity event m used to monitor performance of organizations.

Sentiment analysis refers to classifying customers' comments into categories that may be further analyzed and reported on. Customers' comments may be found on the web, in surveys, within emails, in transcriptions of phone calls or in social media (tweets, comments in Facebook, etc), combinations thereof, and/or the like. Since comments may be provided as free text, sentiment analysis may require text processing. What is needed is a mechanism to extract sentiment from text.

There are at least four general methods used for sentiment analysis including: manual analysis, automated counting of phrases, linguistic analysis and probabilistic/statistical analysis. In manual analysis, a reviewer may read every comment and manually categorizes the comments. Manual methods may take too long and may be fraught with classification errors, as repetition and fatigue may lead reviewers to change their own interpretation of the comments over time.

Automatic counting of preset words or phrases is another alternative. Typically, a word or phrase library or database is organized. Certain words may be judged to be positive words (e.g. happy, delighted, etc.), while other words may be judged to be negative (e.g. awful, dirty). For an example see, Patent Document Identifier US 20090164417 A1, “Topical sentiments in electronically stored communications” filed on Jun. 25, 2009. For another example see Patent Document Identifier US 20050091038 A1, “Method and system for extracting opinions from text documents” filed on Apr. 28, 2005. For still another example see Patent Document Identifier US 20090306967 A1, “Automatic Sentiment Analysis of Surveys” filed on Dec. 10, 2009. These database-driven approaches could be misleading as (a) words may have multiple meanings in different contexts and (b) small changes in a phrase may lead to the phrase not matching an item in the dictionary or database. For example, the word “happy” is generally considered a positive word, unless it is preceded with “not”, in which case it is a negative phrase. The implication of “happy” changes based on the words that precede it. Previous patents have tried to reduce these problems by including a comprehensive set of phrases within the dictionary. No matter how thorough the set is, it may be possible to find small variations to a phrase which will prevent it from being matched to phrases in the database. If the phrase “not happy” is included in the database, it still will not match to “not very happy”, “not that happy”, “not consistently happy” or “I could have been happy”. So many words can change the context of another word that a database approach of listing all possible phrases is not practical. Current embodiments provide a process for learning word combinations from a training set without the need to list phrases a priori.

Linguistic analysis is yet another approach to sentiment analysis. In this approach, word libraries may be created and the meaning of each word and its relationship to other words indicated. The grammar in the sentence may be used to identify the subject of the sentence and the word libraries may be used to classify the subject. In some instances, words like “and”, “or”, “but”, “in spite of” are used to extend relationships learned for one set of words to another. For example, see Vasileios Hatzivassiloglou, et al, “Predicting the semantic orientation of adjectives.”, in Proceedings of the 35th Annual Meeting of the ACL and the 8th Conference of the European Chapter of the ACL, p. 174-181, 1997. See also claims disclosed by Patent Application number 11061335, “Expression extraction device, expression extraction method, and recording medium”, Aug. 25, 2005. For a linguistic approach based on semantic meaning of the words see Patent Document Identifier US 20050125216 A1, “Extracting and grouping opinions from text documents” filed on Jun. 9, 2005. Many linguistic methods analyze the structure and meaning of a comment through a set of rules specified by external experts. These rules may be static until revised again by experts. Words may be used in different ways and machine learning of rules that govern them may be difficult without reliance on statistical analysis. The set of rules useful to classify sentences in one task might be radically different from rules useful in another. For example, “taking a long time” may be considered positive in the context of evaluating physicians but negative in the context of movie plots. One may want doctors to take time with their patients but movies to get to the point and not take too much time. In addition, because linguistic analysis requires fitting sentences into grammatical formats, these approaches fail when the sentence is not grammatically correct (e.g. when the verb is missing). To avoid these problems, linguistic approaches may require extensive preprocessing. Some of the various embodiments employ a process that minimizes preprocessing, and constantly discovers relevant new rules as a case is added to the training set.

The fourth approach to sentiment analysis employs probability models and statistical techniques. In this approach, a training set may be used to learn the relationship among phrases and prediction classes. For example, one may find that the phrase “not happy” tends to occur among complaints and not praises. Once these relationships have been learned, then patients comments may be classified into a complaint or praise, and the complaints may be further classified into various subcategories.

There are a number of statistical approaches that may account for context dependence within sentiment analysis. See for example Fuhr, N. 1985. A probabilistic model of dictionary based automatic indexing. In Proceedings of RIAO-85, 1st International Conference “Recherche d'Information Assistee par Ordinateur”, Grenoble, France, 1985, 207-216. For another example see Cohen, W. W. and Hirsh, H. 1998. Joins that generalize: text classification using WHIRL. In Proceedings of KDD-98, 4th International Conference on Knowledge Discovery and Data Mining, New York, N.Y., 1998, 169-173. See also Cohen, W. W. and Singer, Y. 1999. Context sensitive learning methods for text categorization. ACM Trans. Inform. Syst. 17, 2, 141-173. For examples using Support Vector Machines see Joachims T, 1998, “Text categorization with support vector machines: learning with many relevant features” in Proceedings of ECML-98, 10th European Conference on Machine Learning, Chemnitz, Germany, 1998, 137-142. See also Lewis D D And Catlett J, 1994, “Heterogeneous uncertainty sampling for supervised learning” in Proceedings of ICML-94, 11th International Conference on Machine Learning, New Brunswick, N.J., 1994, 148-156. Finally, see Li Y H AND Jain A K 1998, “Classification of text documents” in Comput J 41, 8, 537-546. These statistical methods of classification may in theory account for the context of a word, assigning different conclusions based on different combinations of words. A potential problem with these and other statistical methods of accounting for the context of words may be that as the number of words within a word combination increases, the probability of observing the combination in the training set decreases, making it impractical to detect the context of long combinations. For example, Patent Document Identifier US 20070033189 A1 “Method and system for extracting web data” filed on Feb. 8, 2007 provides multiple statistical approaches, including a decision tree, to condition the implications of a word based on words that precede it. Theoretically, a decision tree accounts for the context of a word based on the words that appear earlier in the tree structure. Practically, this may not be viable as this method may only analyze word combinations that repeat often. Words that do not co-occur frequently may be ignored in the decision tree, the Support Vector Machine, and other statistical classification systems. While these approaches theoretically account for the context of the word, practically they may not; as the need for large training databases prohibits the use of these approaches.

In text analysis, the context of a word may be set by other words within the same sentence. Training sets are unlikely to be large enough to include all possible combinations of words. Many probabilistic/statistical approaches to analysis of sentences ignore possible combination of words or focus only on word combinations that repeat frequently. These statistical approaches may be relatively accurate on average but tend to make many errors in specific types of sentences. For example, the sentence “I was not happy” may erroneously be classified as praise if the word “happy” occurs frequently and the word combination “not happy” occurs once or a few times in the training data set. Statistical classification systems are susceptible to frequency with which word combinations occur in the training set.

The distribution of word combinations is not a small problem. As the length of a word combination increases, the word combination may occur less often within the training set, sometimes occurring only once. Probabilistic/statistical approaches (e.g. Decision Tree, Discriminant Analysis, Support Vector Machine) may have a difficult time learning from a single case. Probabilistic/statistical approaches may need repetition of the word combination to accurately estimate its impact. Since there are many words in the language, many word combinations occur only once in even large training data sets. For example, in a database of nearly 10,000 comments, it was observed that almost all 5 word combinations, the majority of 4 word combinations and nearly 50% of 3 word combinations occur only once. Ignoring the information in these word combinations may lead to a large portion of the training set being ignored. Some of the various embodiments overcomes the limitation of probabilistic/statistical methods and may learn from a single case. Thus, some of the various embodiments not only provides context-dependent understanding of words but may do so in moderately sized training sets, where many word combinations repeat once or a few times.

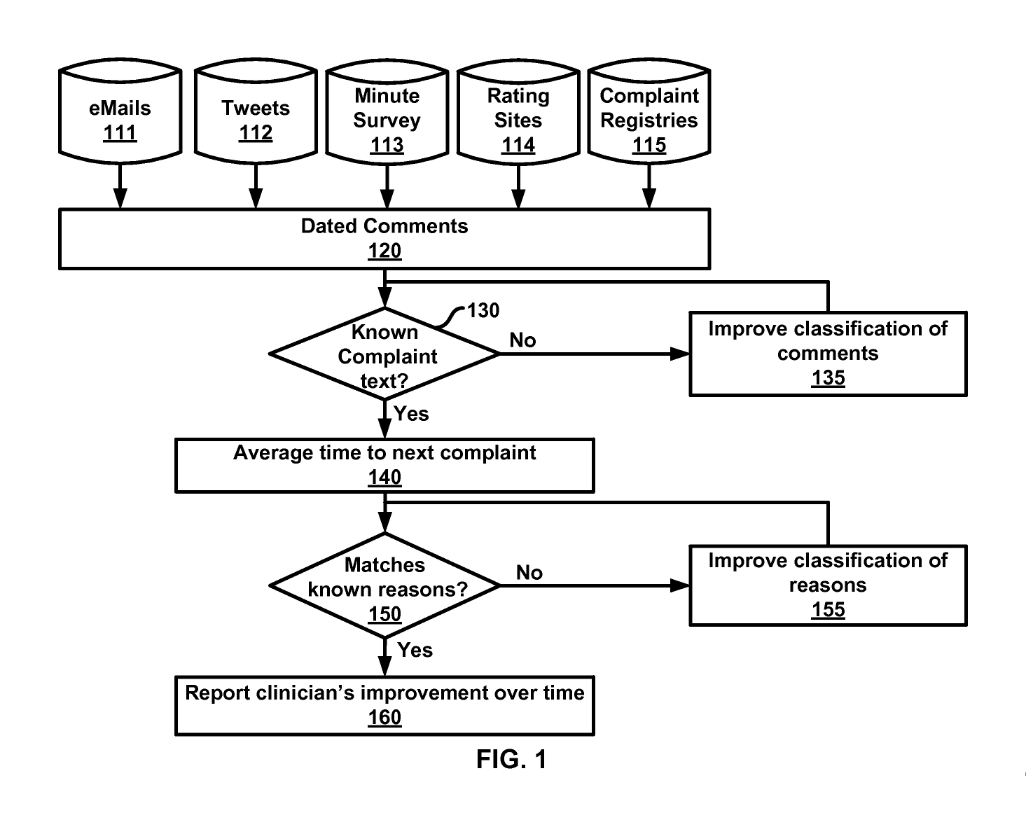

Embodiments of the present invention classify text into multiple categories. Classifying text into two categories may be referred to as setting the polarity of the text. FIG. 1 is a block diagram of one embodiment in which the present invention can be used. In this example, patient comments are obtained from five different sources: (1) responses to surveys, (2) emails, (3) tweets and other social media, (4) formal complaints to health care providers, (5) web rating sites. All comments are merged into a database that contains the text of the comment and the date of the comment. An initial training set is classified manually and the present invention is then used to classify succeeding cases. If the invention fails to classify a comment, a system administrator classifies it and adds the new instance to the training set. The time period between complaint is used to monitor healthcare provider's performance. When the average time between complaints increases, the healthcare provider is improving. When it decreases, for no apparent external reasons, the performance is deteriorating. The system provides a real time analysis of heath care providers as patient comments are received.

FIG. 1 is a block diagram showing real time monitoring of clinicians as per an aspect of an embodiment of the present invention.

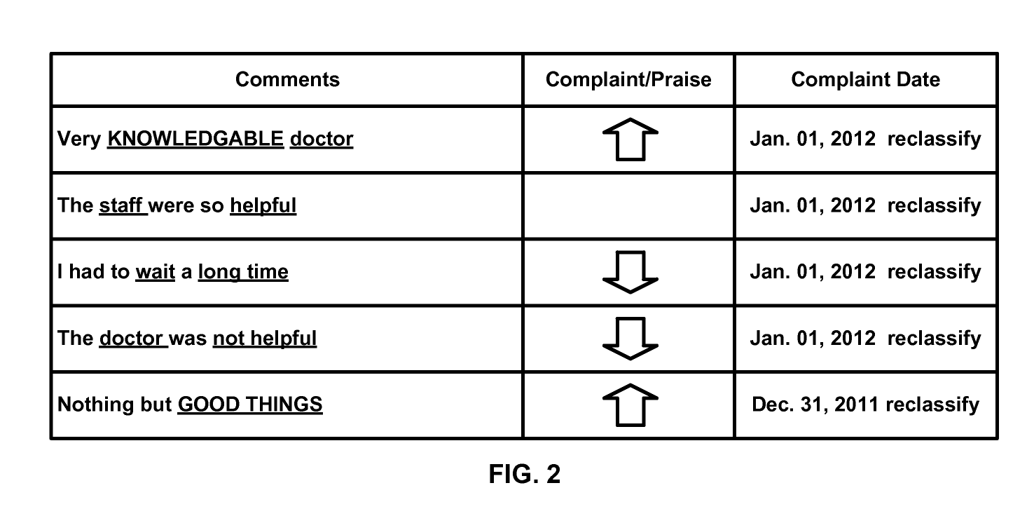

FIG. 2 is an illustration of a display as per an aspect of an embodiment of the present invention. As illustrated, comments are displayed with words indicative of a complaints and praise. The word indicative of complaints are underlined and in lower case. Words indicative of praise are underlined and in UPPER case. The classification for the complaint is indicated by an up arrow (praise) or a down arrow (complaint).

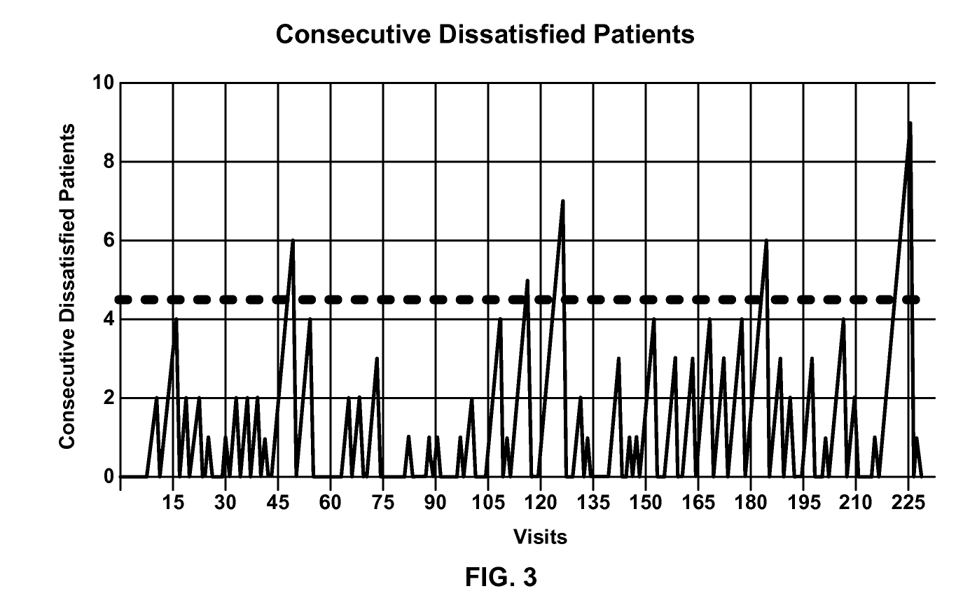

FIG. 3 is an illustration of a user interface showing monitored clinic performance using sentiment analysis as per an aspect of an embodiment of the present invention. Once a patient comment is classified as a complaint, the consecutive number of complaints may be used to track the performance of a clinic in real time. The control limit for consecutive number of complaints may be set based on R, the ratio of complaints to praises.

The X-axis the FIG. 3 shows visit numbers. The Y axis shows the consecutive number of unsatisfied patients. The flat line is a control limit. When the number of consecutive complaints exceeds the control limit, then significant non-random changes may have occurred in the underlying clinic process.

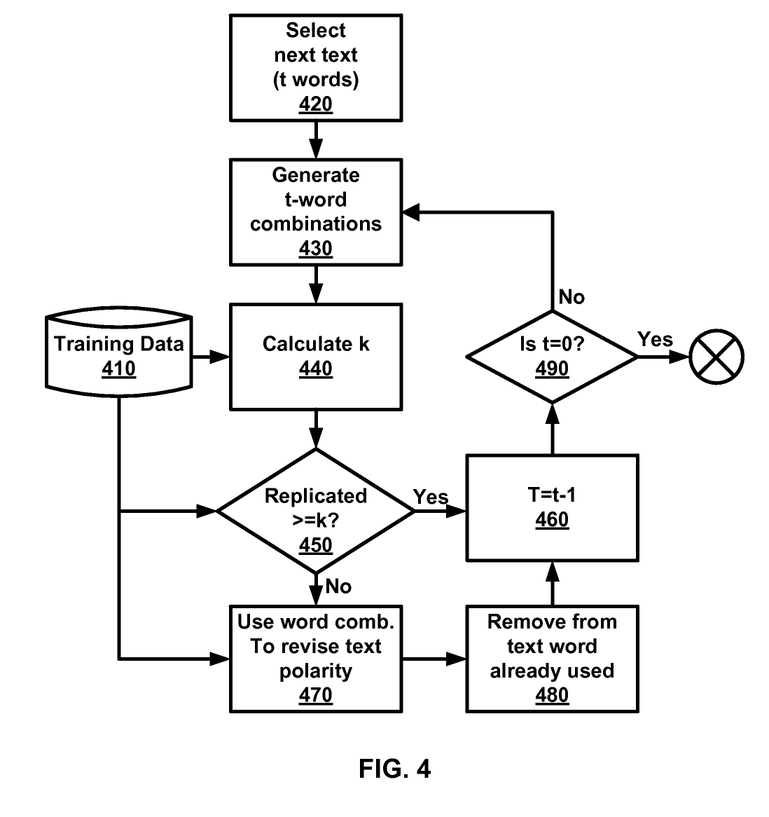

FIG. 4 is a flow diagram showing the establishment of the polarity of text as per an aspect of an embodiment of the present invention. This example flow may be used to finding the Longest Word Combination that Repeats k Times. The presence of a training database is assumed at 410. New text may be selected for analysis at 420. Word combinations of length “t” may be generated at 430. For each word combination, the parameter k may be calculated at 440. Word combinations that repeat more than k times in the database may be used to revise the polarity of the text at 470. Word combinations that repeat less than k times may be ignored. Words used in revising the polarity of the text may be removed from the text at 480. The size of word combinations “t” may be reduced by one at 460. If “t” is not zero, a new set of word combinations of size t may be generated at 430.

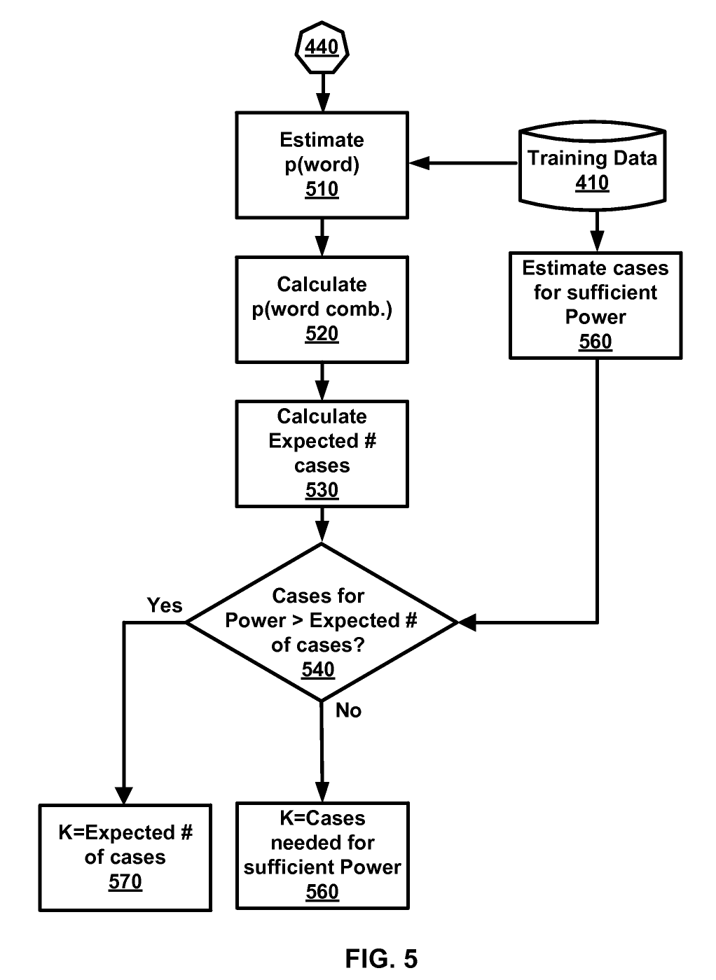

Example FIG. 5 shows a flow diagram for operation 440 to access the minimum number of replications. At 510, the probability of each word within the word combination may be estimated from the probability of the word occurring in the training data set. At 520, a determination of whether the word combination has significance as a whole, or is just a random combination of the individual words may be made. The probability of randomly observing all words within the word combination may be calculated as the product of probabilities of observing the individual words. At 530, the number of occasions one can expect the word combination to repeat within the training set may be calculated by multiplying the probability of the word combination by the number of cases within the training set. At 540, the number of cases needed for power of 80% and significance level of 95% may be estimated using the training data set. At 550-570, the number of replications may be set to the minimum of the expected number of cases for the word combination or the number of cases needed for sufficient power and significance level.

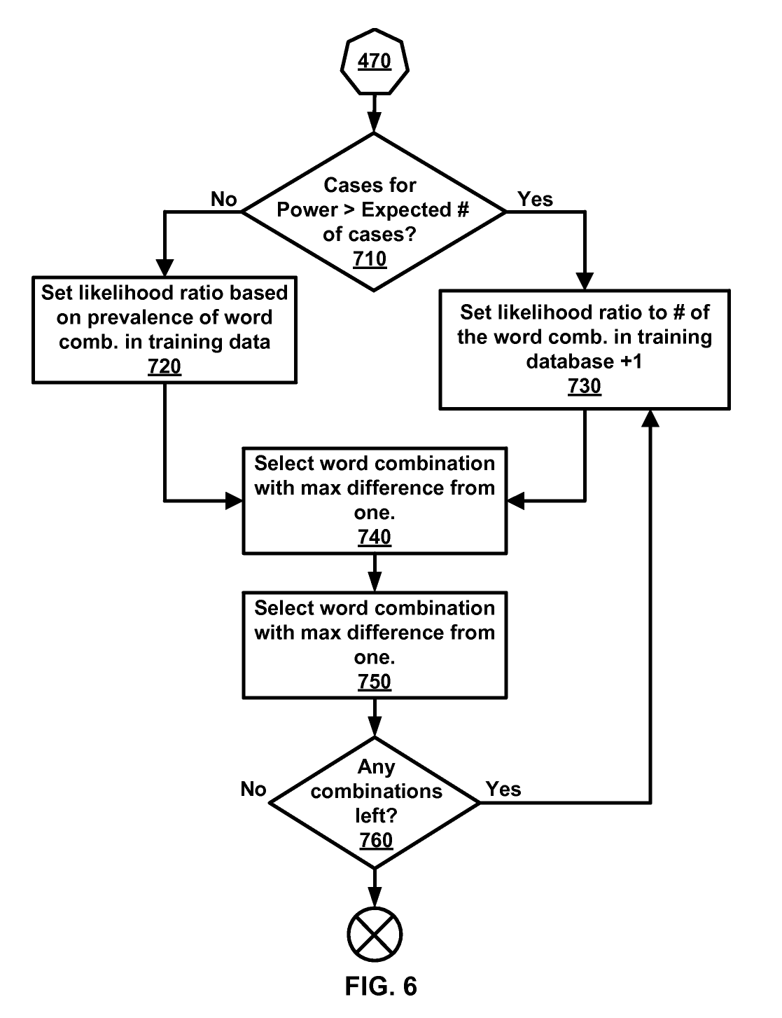

FIG. 6 is an example flow diagram as per an aspect of an embodiment of the present invention. Specifically, FIG. 6 shows an example expansion of block 470 in FIG. 4. In this example, the example flow diagram shows the selection of overlapping word combinations actions. Often, more than one word combination of length “t” may be considered for the analysis. The likelihood ratio for each word combination of length “t” may be calculated based on either the prevalence of the word combination in the training set at 610, or based on the number of word combination in the training set plus one at 630. Once the likelihood ratios associated with each word combination have been calculated, the word combination with a likelihood ratio most different from one may be selected at 640. Word combinations that overlap with the selected word combination may be eliminated at 650. If any combinations are determined to be left at 660, the process of selecting word combinations may be continued until no word combination of length t remain.

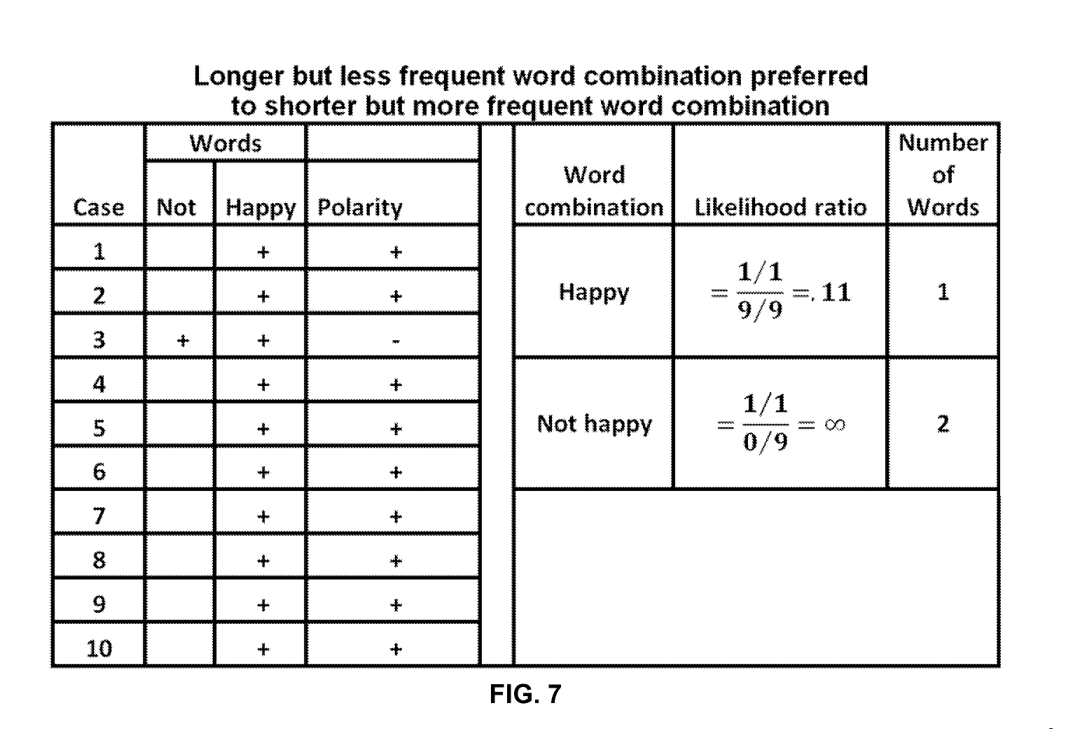

FIG. 7 is an example diagram illustrating how both the length and width of the training data set may matter in analyzing a sample text: “not happy”. In this example, the word “happy” repeats 11 times, 10 times among praises and 1 time among complaints. The combination “not happy” is longer but occurs only once in the database. The process may prefer longer, less frequent word combinations over shorter more frequent word combinations because longer word combinations provide additional context for the words.

Description of example processes according to some of the various embodiments.

Some of the various embodiments may be used, for example, to replace patient satisfaction surveys. Instead of costly and long surveys, patients may be asked to respond to one question: “What worked and what needs improvement?” The example embodiment may be used to classify patient comments into complaints/praise and to further classify the complaints into sub-categories (see, for example, FIG. 1). Health care providers may be given information about polarity of the comments (see, for example, FIG. 2), types of complaints, as well as percent of visits with a complaint/praise. These types of reports may recreate ones typically available through longer satisfaction surveys.

Some of the various embodiments may be used to classify text received over time into categories. Time or number of events till negative polarity may then be used to monitor performance of an organization. For example, “visits until a complaint: may be used to monitor satisfaction with care delivered at a clinic. A control limit may be set based on the number of consecutive complaints (see, for example, FIG. 3). More details of how control limits for consecutive complaints may be set see Alemi F, and Hurd P, “Rethinking satisfaction surveys: days to next complaint.” in the Joint Commission Journal on Quality and Patient Safety, 2009, 35(3): 156-61. Some of the various embodiments may shows how the classification of comments works. When aspects of various embodiment(s) are combined with control charts for consecutive complaints, the embodiments may provide a procedure for monitoring performance of organizations in real time.

There are at least two conceptually distinct ways to analyze text using statistical methods: Bayesian probability model(s) and case-based reasoning (e.g. k Nearest Neighbor, kNN, procedure(s)). The Bayesian approach may predict the polarity of the text based on words in the text, sometimes referred to as features when processing non-text data. The relative importance of each word/feature may be established based on the likelihood ratio associated with the word within the training set. The kNN, and all similar case based reasoning approaches may rely on the similarity of a text to other texts. For example, entire sentences may be compared to each other and sentences that share more features judged to be more similar. Feature and case based approaches, i.e. Bayes and kNN approaches, are dual solutions to the same problem and may lead to the same conclusion. When feature and case based approaches do lead to the same conclusion, there may be more confidence in the prediction; when they do not, there may be concern about the accuracy of the prediction. In the presently claimed process, agreement between case-based and feature-based reasoning may be employed to guide the prediction task.

Terminology

A word is any combination of letters; thus words do not need to be spelled correctly or belong to the English language. A conceptually unique word within the sentence “j” as W_{i,j,} where, i=1, . . . , tⱼ and “tⱼ” may indicate the number of unique words in the sentence. For simplicity, “tⱼ” may be shown as “t”, whenever it is clear which sentence is being referenced. Words in a sentence may be mapped to their stem. Singular/plural versions of the same word, common misspelled version of the word, various tenses of the word, or modification of the word into adjective/adverbs may be mapped to the same word stem. Thus, “hapy”, “happy,” “happier” and “happiest” may be considered the same word. Processes for mapping to a stem (for example see Julie Beth Lovins, 1968, “Development of a stemming algorithm.” in Mechanical Translation and Computational Linguistics 11:22-31.) may be available, although a simple method may be to use a database of equivalent words. A “sentence” may be a collection of sequenced words. A sentence does not need to be grammatically correct or contain a verb; but it must have sequence among the words and at least one word. Two sentences that share the same words but in different order may not be considered the same sentences. Consecutive words within the sentence may be referred to as a “phrase”; the literature also refers to a phrase as an n-gram, where n is the number of words in the phrase. “Combination of words” refers to the collection of words in a sequence within a sentence but not necessarily consecutive words. All phrases are combination of words but not vice versa. In the sentence, “I was very happy”, there are 4 words. The largest word combination is the entire sentence with 4 words. The next largest word combinations (3 words) are “was very happy,” “I very happy”, “I was very” and “I was happy”. Note that the set “very happy” is both a phrase and a word combination; the set “was happy” is a word combination but not a phrase, as it is not consecutive; and the set “happy was” is neither a phrase nor a combination, as it is not in observed sequence.

The relationship between combinations of words and an outcome of interest may be learned from a training set of sentences. Each sentence in the training set may be classified by a human reviewer. The classification of sentence “j” may be shown as Yj. One sentence within the training set may be referred to as a case. Case-based reasoning refers to the process of learning from the sentences within the training set, typically through similarity of sentences to each other.

Sets are be shown in bold capital letters, probability functions as p( ) with the event described in the parentheses. Note that two different set of indexes are employed: “j” is typically used for cases and “i” for words. For sentence “v”, our task is to predict Yᵥ based on a set of “t” words within the sentence:

V=[W_{1,v},W_{2,v}, . . . ,W_{f,v}, . . . ,W_{t,v}]

Prediction(s) may be made based on the training set T:

T=[X_{1,j},X_{2,j}, . . . ,X_{f,j}, . . . ,X_{t,j},Yⱼ]j=1, . . . ,g

Note that “t” is the set of words in the sentence “v” and not words within the cases in the training set. In order to separate a case in the training set from a case in the validation set, we show the cases in the training set with the index value of “j” and the cases in the validation set with the index value of “v”. We assume that the predicted Y is binary, i.e. Yⱼ=1 or Yⱼ=0. The number of cases in the training set is given by “g.” The function p(Yᵥ|X_{1,v}, X_{2,v}, . . . , X_{t,v}) indicates the posterior probability of Y given the “t” words of the case “v”.

The function m( ) indicates the match between case “v” in the validation set and case “j” in the training set on word “f.” It may be defined as follows:

$${M}_{f , v , j} = \{ \begin{matrix}1 , & {X}_{f , j} = {X}_{f , v} \\ 0 , & {X}_{f , j} \neq {X}_{f , v}\end{matrix}$$

When the word “f” is in both sentences, the function may have the value of one. Otherwise, it may have the value zero.

Case-Based Reasoning

One method of case based reasoning is the K Nearest Neighbor (kNN) procedure. For traditional methods of using kNN see Bremner D, Demaine E, Erickson J, Iacono J, Langerman S, Morin P, Toussaint G (2005). “Output-sensitive algorithms for computing nearest-neighbor decision boundaries” in Discrete and Computational Geometry 33 (4): 593-604. In the kNN approach, the posterior probability of Yᵥ may be approximated as the average of k nearest case to case “v.”

$$p ( {Y}_{v} \vert {X}_{1 , v} , {X}_{2 , v} , … , {X}_{t , v} ) = \frac{{Σ}_{c} {Y}_{c}}{k} \\ ( c \text{:} k closest cases to case v )$$

Various investigators have made different suggestions, e.g. using Pythagorean equation, for how to measure the distance between case “v” and cases within the training set. A psychologically valid method of measuring similarity of two cases is given by Tversky, A, 1977, “Features of similarity” published in Psychological Review, 84 (4), 327-352. This method measures the similarity of two cases as:

$${S}_{v , j} = \frac{{M}_{v , f}}{{M}_{v , f} + {wI}_{v , not} + ( 1 - w ) {O}_{not v , j}}$$

Where M_{v,j} is number of words in both sentences. I_{v,not j} is number of words in validation sentence “v” but not in training sentence “j”, O_{not v,j} is the number of words in the training sentence “j” and not in the validation sentence “v” and w is a constant between 0 and 1.

Note that if two cases are exactly the same, then S_{v,j} may be one. If the two cases have nothing in common, then S_{v,j} may be zero. As more words are matched, the similarity scores may increase proportional to the number of words matched; the similarity score may decrease as the number of mismatched words increases. Tversky's measure of similarity counts as a mismatch both words in the validation sentence but not in the training sentences; or vice versa.

In the kNN procedure, the word combination may be employed to make a prediction, if the entire word combination has a minimum number of replications. This minimum number typically relies on the training data set and may be found by trial and error. For alternatives to the trial and error procedures, see the work of D Coomans, D L Massart, 1982, “Alternative k-nearest neighbor rules in supervised pattern recognition: k-Nearest neighbor classification by using alternative voting rules” in Analytica Chimica Acta 136: 15-27. In trial and error as well as in existing alternative approaches, the same k value may be employed independent of the length of the sentence or length of word combination being examined. According to several of the various embodiments, the kNN approach may be modified to rely on different minimums depending on the length of the word combination being examined. If “m” indicates the length of the word combination, then “kₘ” may be the number of replications needed before kNN can be used.

Determination of Minimum Number of Replications

The determination of the minimum number of replications, kₘ, may be used in block 440 of FIG. 4 and described in FIG. 5. The kₘ parameter may be calculated from the minimum of two competing procedures, one based on words in the sentence and the other based on cases in the training set:

kₘ=minimum[E,Q]

where, E is the expected number of times that the word combination l would randomly replicate in the training set (position 430 FIG. 5). It is calculated as:

$$p ( {Y}_{v} \vert {X}_{1 , v} , {X}_{2 , v} , … , {X}_{t , v} ) = \frac{{Σ}_{c} {Y}_{c}}{k} \\ ( c \text{:} k closest cases to case v )$$

where: p(Mₗ) is the proportion of times that cases in the training set match on word “l” and “l” is a word within word combination L seen in case V, g is the total number cases within the training set.

The constant Q, employed in block 550 in FIG. 5, may be determined as:

$$Q = \frac{{z}^{2} p ( {M}_{f} ) ( 1 - p ( {M}_{f} ) )}{{u}^{2}}$$

Where: p(M_{f}) is the proportion of times that cases in the training set match on feature “f”. 1−p(M_{f}) is the proportion of times that cases in the training set do not match on feature “f”. p(M_{f}) may typically be assumed to be 0.50; the significance level may typically be set at 95%, which corresponds to z=1.96 for the normal distribution; u is the difference in the probability of matching that some of the various embodiments desire to detect with a power of 80% and may typically be set to 0.10. Under these typical assumptions Q=96.

To understand how the parameter kₘ is calculated, consider two different scenarios. In the first case, dealing with a single word sentence, where the word may be found in 1% of the sentences in the training set, i.e. p(M_{f})=0.01, and the total size of the training set is g=10,000 cases. Under these assumptions:

E=10000×0.01=100

Q=96

kₘ=minimum[E,Q]=96

Now assume a five word sentence where each word has a probability of 1% of being matched in the training set. In this circumstance:

E=10000×0.01×0.01×0.01×0.01×0.01=0.000001

Q=96

kₘ=minimum[E,Q]=0.000001

In these circumstances, if there is at least one sentence with the same set of words in the training set, then there may be sufficient evidence to proceed with the kNN procedures. In this situation, the kNN may predict from the outcome of a single case in the training set.

### Example

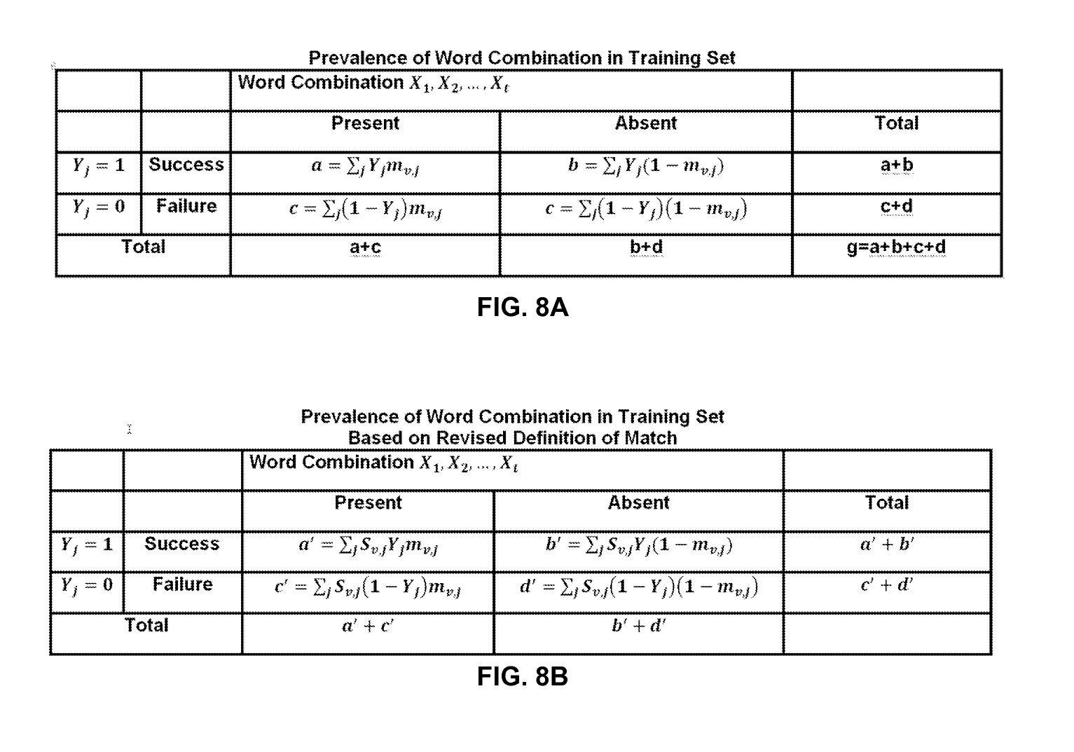

Models may be built so that the k Nearest Neighbor (kNN) and Bayes lead to the same conclusions. The logic is that two approaches to the same data have the same conclusions then there may be more confidence in the findings. The following shows how to this. Suppose that we want to evaluate how a combination of words, X₁, X₂, . . . , Xₜ, might affect the predictions in both the Bayes and kNN approaches. Assume that m_{v,j}=1 indicates the match in the validation case “v” and training case “j” on a phrase of size “t”. If there is not an exact match to the “t” words in the phrase then m_{v,j}=0. The table in FIG. 8 indicates the components needed for calculation of the Likelihood Ratio, LR, associated with the phrase.

The Bayes approach may calculate the likelihood ratio associated with the word combination X₁, X₂, . . . , Xₜ as:

$$L R = \frac{a}{c} \times \frac{c + d}{a + b}$$

After examining the first set of words, the posterior odds, PO, for a case in the validation set, may be calculated as:

$$P O = L R \times PR = \frac{a}{c} \times \frac{c + d}{a + b} \times \frac{a + b}{c + d} = \frac{a}{c}$$

In a KNN approach, if the distance function is assumed to be that all cases that match on X₁, X₂, . . . , Xₜ words may be the same (similarity of 1) and all others may be different (similarity of 0), and if we assume that k=a+c, then the predicted statistic for kNN may also be

$$\frac{a}{c} .$$

If a<c, then prediction for case v that contains X₁, X₂, . . . , Xₜ and nothing else is Yᵥ=1. If a=c, then there are no predictions. If a<c, then the prediction is Yᵥ=0. The two approaches under these assumptions lead to the same conclusion at this stage of the analysis. There are two ways in which the KNN and the Bayes approach could have different predictions.

First, Bayes approach continues to examine other sets of words and the likelihood ratio associated with these words or phrases may change the prediction of Bayes. This may occur if a+b exceeds the number of cases needed to assess the likelihood ratio of the next set of words. Typically, because the combination of “t” words is rare, a+b is a small number, say less than 30 cases, then it may be difficult to accurately calculate the conditional likelihood ratio associated with these new words and therefore the Bayes and kNN will have the same conclusion.

The second way kNN and Bayes may differ is if the distance function is changed. The proposed distance function may not make sense because it does not take into account other words present in the same sentence. To say that two sentences are exactly the same, when they match “t” words ignores the fact that these sentences may have a large number of words that do not match. An alternative distance function is to use Tversky's similarity function where:

$${S}_{v , j} = \frac{{m}_{v , j}}{{m}_{v , j} + {i}_{v , j} / t + {o}_{v , j} / t}$$

Where i_{v,j} is the number of words in validation case “v” and not matched to the phrase of size “t” in training case “j”; o_{v,j} is the number of words not matched to phrase of size “t” in validation case “v” but in training case “j”. In order for the Bayes and kNN to have exactly the same predictions, one may eed to adjust what is considered a match in Bayes equation. The revised Table in FIG. 8A may now be calculated as shown in the revised table shown in FIG. 8B. The revised likelihood ratio associated with the revised definition of match is:

$${LR}^{′} = \frac{{a}^{′}}{{c}^{′}} \times \frac{c + d}{a + b}$$

The posterior odds for the validation case may be calculated as:

$${OD}^{′} = \frac{{a}^{′}}{{c}^{′}}$$

This revised Bayes prediction agrees with the kNN prediction under the assumption that k=a′+c′ and the assumption that a′+c′ is small. One may now also relax the latter assumption by excluding from consideration any set of words that lead to a′+c′ value larger than a constant and for which the subsequent word set has a likelihood ratio that disagrees with LR′.

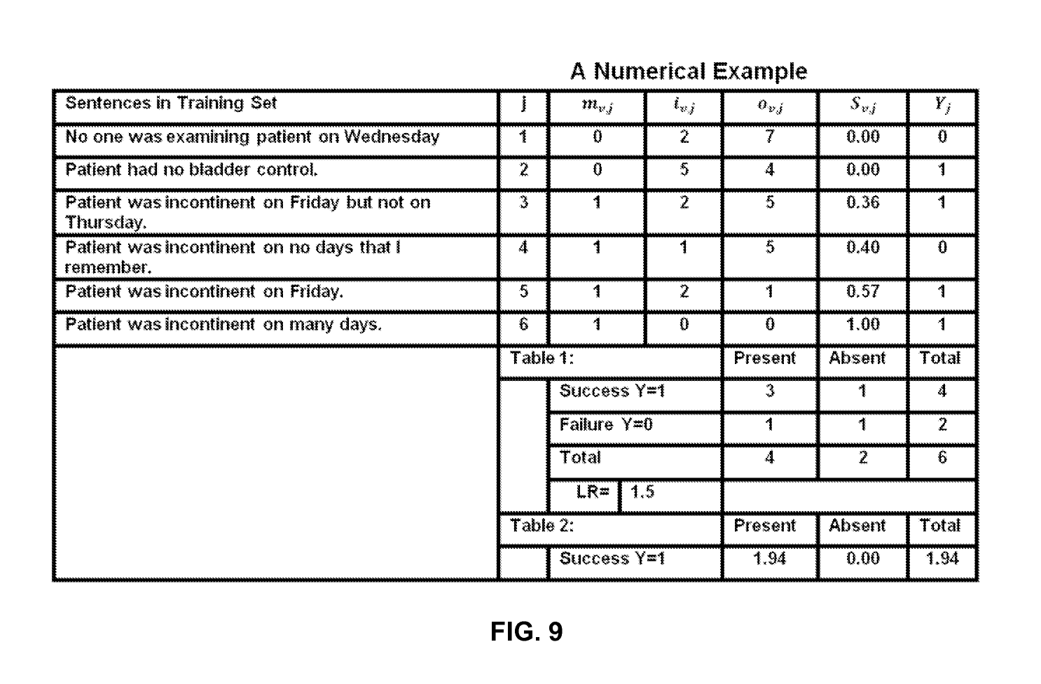

FIG. 9 is example table showing a numerical example for calculation an example phrase employing an aspect of an embodiment of the present invention. Specifically, the table in FIG. 9 shows a numerical example for calculation of the phrase “Patient was incontinent on” within the sentence “Patient was incontinent on many days.”

Alternative Approach to Test of Significance

The above procedure shows how the significance of a word combination may be determine using the Q variable to test the number of observed replications of the phrase. An alternative approach based on the natural logarithm of the ratio of the likelihood ratio associated with the phrase will now be disclosed. To begin with, the likelihood ratio associated with a phrase may be calculated as follows:

$$L R = \frac{p ( Phrase \vert Y = Positive )}{p ( Phrase \vert Y = Negative )} = \frac{\frac{{N}_{Phrase , Positive}}{{N}_{Positive}}}{\frac{{N}_{Phrase , Negative}}{{N}_{Negative}}} = \frac{{N}_{Phrase , Positive}}{{N}_{Phrase , Negative}} \times \frac{{N}_{Negative}}{{N}_{Positive}}$$

The odds ratio may be calculated as the ratio o two likelihood ratios. To test if the likelihood ratio is significantly different from 1 to 1, L, the natural log of the odds ratio may be calculated as:

$$L = Ln ( \frac{{N}_{Phrase , Positive}}{{N}_{Phrase , Negative}} \times \frac{{N}_{Negative}}{{N}_{Positive}} )$$

The distribution of the log odds ratio, L, is approximately normal. Therefore, the approximate 95% confidence interval for the population log odds ratio may be estimated as:

$$L \pm 1.96 \sqrt{\frac{1}{{N}_{Phrase , Positive}} + \frac{1}{{N}_{Phrase , Negative}} + \frac{1}{{N}_{Negative}} + \frac{1}{{N}_{Positive}}}$$

The number of replications may be insufficient if the 95% confidence interval includes zero. For situations where N_{Phrase,Positive}=0 then L may be calculated as follows:

$$L = Ln ( \frac{1}{{N}_{Phrase , Negative} + 1} )$$

$$L \pm 1.96 \sqrt{\frac{1}{1} + \frac{1}{{N}_{Phrase , Negative}} + \frac{1}{{N}_{Negative}} + \frac{1}{{N}_{Positive}}}$$

For situations where N_{Phrase,Negative}=0 then L may be calculated as:

$$L = Ln ( {N}_{Phrase , Positive} + 1 )$$

$$L \pm 1.96 \sqrt{\frac{1}{{N}_{Phrase , Positive}} + \frac{1}{1} + \frac{1}{{N}_{Negative}} + \frac{1}{{N}_{Positive}}}$$

Bayesian Prediction

The Bayesian probability model may be used to revise the polarity of a text at block 470 in FIG. 4. The Bayesian probability prediction differs from the kNN approach in that it relies on the prevalence of words within the text. In this approach and for a text within V, the posterior odds of Yᵥ=1 is shown as PO and may be calculated as:

$$\begin{matrix}P O = \frac{p ( {Y}_{v} = 1 \vert {X}_{1 , v} , {X}_{2 , v} , … , {X}_{t , v} )}{p ( {Y}_{v} = 0 \vert {X}_{1 , v} , {X}_{2 , v} , … , {X}_{t , v} )} \\ = \frac{p ( {X}_{1 , v} , {X}_{2 , v} , … , {X}_{t , v} \vert {Y}_{ v} = 1 )}{p ( {X}_{1 , v} , {X}_{2 , v} , … , {X}_{t , v} \vert {Y}_{v} = 0 )} * \frac{p ( {Y}_{v} = 1 )}{p ( {Y}_{v} = 0 )}\end{matrix}$$

Under the assumption of equal priors, a common assumption when sentences have many words, the calculation may be simplified to:

$$P O = \frac{p ( {X}_{1 , v} , {X}_{2 , v} , … , {X}_{t , v} \vert {Y}_{v} = 1 )}{p ( {X}_{1 , v} , {X}_{2 , v} , … , {X}_{t , v} \vert {Y}_{v} = 0 )}$$

In particular, posterior odds may be calculated as the ratio of the prevalence of the sentence in two different outcomes, Yᵥ=1 and Yᵥ=0. This ratio may be referred to as a likelihood ratio for the sentence and may be calculated from the training data set:

$$L R = \frac{p ( {X}_{1 , v} , {X}_{2 , v} , … , {X}_{t , v} \vert {Y}_{v} = 1 )}{p ( {X}_{1 , v} , {X}_{2 , v} , … , {X}_{t , v} \vert {Y}_{v} = 0 )}$$

Except for trivial sentences with a few words, this ratio may not be calculated as the entire sentences do not typically repeat in the training set. Under the assumption of conditional independence, the likelihood ratio of the sentence may be calculated from the likelihood ratio associated with each word within the sentence:

$$LR = \frac{p ( {X}_{i , v} \vert {Y}_{v} = 1 )}{p ( {X}_{1 , v} \vert {Y}_{v} = 0 )} * \frac{p ( {X}_{2 , v} \vert {Y}_{v} = 1 )}{p ( {X}_{2 , v} \vert {Y}_{v} = 0 )} * … * \frac{p ( {X}_{t , v} \vert {Y}_{v} = 1 )}{p ( {X}_{t , v} \vert {Y}_{v} = 0 )}$$

$$LR = {LR}_{1} * {LR}_{2} * … * {LR}_{t}$$

This approach simplifies the calculation of the likelihood ratio, but the assumption of conditional independence may be violated by many word combination. If the meaning of a word changes by an additional word in the sentence, then the meaning may be context dependent and the assumption of independence of the two words may be violated. For example, the likelihood ratio for the word combination “not happy” may be radically different from the product of the likelihood ratio of “not” and “happy.” The word “not” changes the context in which “happy” is understood. In this circumstance, the two words are dependent on each other. One way to improve Bayes predictions is to process large dependencies among the words as word combinations and other words as independent words. Then, the crucial question in application of the Bayes prediction rule may become which words should be examined as a combination and without the assumption of conditional independence.

Combining Probability and Case Based Reasoning

Bayes and kNN are two different approaches that may be employed to predict the same outcome. There may be more confidence when these two approaches lead to the same conclusion. One situation where the kNN and Bayes approaches agree is when the same word combinations used in predicting the outcome with kNN may also be used in calculating the Bayesian prediction. In these circumstances, Bayes calculations start from the same point as the kNN approach. If additional words used in the Bayes prediction do not change the conclusions arrived at through the word combination then the two approaches may lead to the same conclusion. In order to reduce the chances that additional words do not change the conclusion arrived at through the word combination used by kNN, it may be important to take the maximum length of a word combination. This may reduce the number of words left to be processed in Bayes formula as independent words. Starting with the longest possible combination has an additional benefit. The longer the word combination, the more rare the combination, and the more likely that the word combination occurs in only one of the two possible outcomes. As can be seen shortly, this may lead to near zero or near infinity estimates for the likelihood ratio. These extreme likelihood ratios may not be as likely to be overturned by the likelihood ratios associated with single words, which are prevalent in both outcomes. FIG. 4 shows how both the kNN requirements of replications and Bayes use of likelihood ratios may be combined according to some of the various embodiments.

Estimating Extreme Likelihood Ratios

In calculating a likelihood ratio associated with a word combination, occasionally there may be a situation where the calculations lead to division or multiplication by zero. These may be referred to as extreme likelihood ratios. These extreme values may not be acceptable because they do may not allow for revision of the polarity of the text based on other word combinations within the same sentence. This section describes how to estimate a less extreme value in these situations. This is also shown in block 630 in FIG. 6.

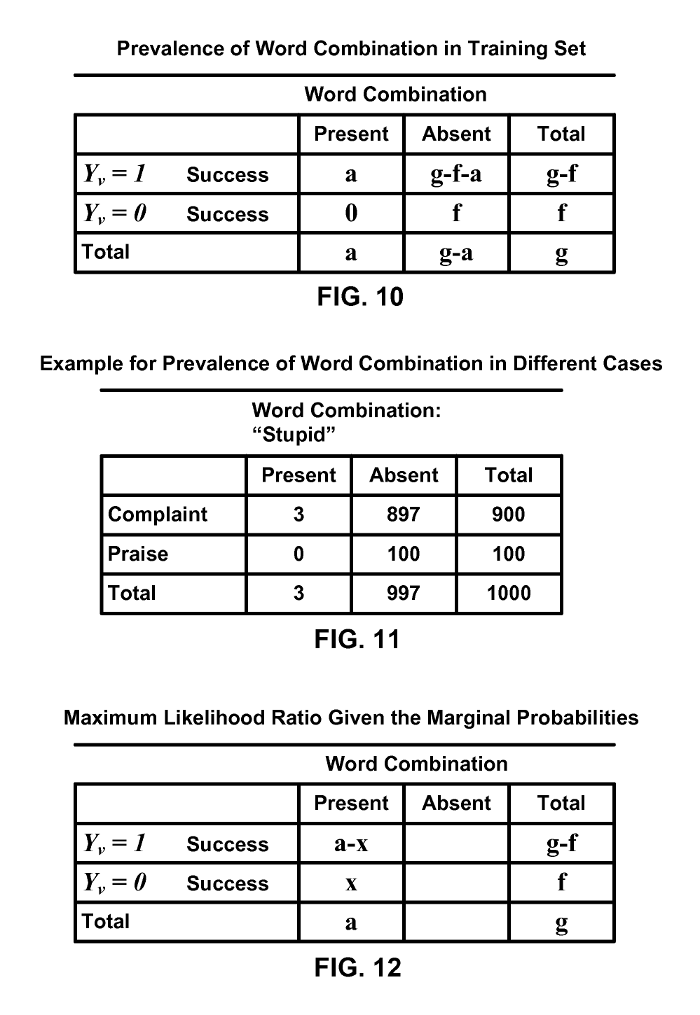

A word combination may be present or absent in each training case. In calculating a likelihood ratio, a situation is often faced where the word combination may not occur in successes or in failures at all. In these situations, there may be a likelihood ratio that is zero or calculated as division by zero. For example, considering the data in the table in FIG. 10 which shows the prevalence of word combinations in an example training set employed by an aspect of an embodiment of the present invention. In this table, “a” is the number of times the word combination repeated in the training set. “g” is the size of the training set. “f” is the number of times the comment is classified as “Yᵥ=0” or “Failure.” The variables “a”, “g” and “f” are positive integers, g>f>0, and a>0.

The likelihood ratio associated with the word combination may be calculated as follows:

$$L R = \frac{\frac{a}{g - f}}{\frac{0}{f}} = \frac{α}{0} \times \frac{f}{g - f} = ∞$$

$$g > f > 0$$

$$a > 0$$

Computers may not process a likelihood ratio of infinity and therefore it is important to replace this value with a very large number that for all practical purposes behaves like a likelihood ratio of infinity and may be processed by the computer. A question is how large should the likelihood ratio be. Prior processes have tried to estimate this extreme likelihood ratio by adding a small amount (0.5) to each of the cells in Table 1 (FIG. 8A). See Feinstein A R. Clinical epidemiology: the architecture of clinical research. Philadelphia: Saunders, 1985:43. Feinstein estimates the likelihood ratio as:

$$\hat{LR} = \frac{a}{0 + c} \times \frac{f + c}{g - f}$$

$$c = .5$$

There are two potential problems with this approach. First, the correction factor c=0.5 seems arbitrary and with different values of the correction factor, one obtains different results. Second, in analysis of rare words, it is possible for the estimate of the likelihood ratio to contradict the conclusion reached by the likelihood itself:

$$L R = ∞ > 1$$

$$\hat{LR} = \frac{α}{0 + c} \times \frac{f + c}{g - f} < 1$$

Other processes suggest creating a confidence interval for the likelihood ratio, where one end of the interval is Feinstein's estimate. See Black W C. Reply to Letter to Editor Likelihood Ratio, American Journal of Radiology, 1987, 148, 1272-1273. These approaches may face the same problem as Feinstein, in the sense that the estimate and the calculated likelihood could lead to different conclusions.

An example may demonstrate this problem. In the example provided in the table in FIG. 11, the likelihood ratio associated with the presence of the words “Doctor was stupid” is infinite. In 1,000 cases in the training set, where 90% of sentences are complaints, the word combination “Doctor was stupid” may be found in 3 cases among complaints and none among praises.

Clearly, the word “Stupid” should strongly suggest a complaint, as the likelihood ratio is larger than one and in fact infinity:

$$L R = \frac{3}{0} \times \frac{100}{900} = ∞ > 1$$

By adding a constant 0.5 to all cells, the estimated likelihood ratio is surprisingly low:

$$\hat{LR} = \frac{3}{.5} \times \frac{100.5}{900} = 0.67 < 1$$

The estimate is not only small but also it has the opposite implication; it now implies that the word combination indicates praise, as the likelihood ratio is less than 1. The estimate and the calculated value suggest two different conclusions.

To remedy this situation, a new procedure of estimating extreme likelihood ratios may be employed. The likelihood ratio may be estimated based on the maximum estimate possible given the parameters of the training set, in this case, “a”, “g” and “f”. Since division by zero may not be possible, this may be the highest likelihood ratio that can be calculated from the training data set. To estimate the maximum likelihood ratio that can be calculated from the training set, imagine the table in FIG. 12, where the marginal values are fixed and the only unknown is the “x” value:

The likelihood ratio associated with the marginal probabilities in the table in FIG. 12 may be calculated as:

$$L R = \frac{\frac{a - x}{g - f}}{\frac{x}{f}} = ( \frac{α}{x} - 1 ) \times \frac{f}{g - f} < \frac{α}{x} \times \frac{f}{g - f}$$

$$x = 1 , 2 , … , a$$

Since “a”, “g”, “f” are fixed positive integers, the maximum value of any likelihood ratio given the marginal probabilities may occur at lowest value for “x” and may be calculated as:

$$\hat{LR} > {LR}_{Max \vert g , f , a} = \frac{af}{g - f}$$

$$g > f > 0$$

$$a > 0$$

Note that LR_{Max|g,f,a} Increases proportional to “a”, the number of occasions of observing the word combination. This is reasonable because when “a” is large, there may be more confidence that Yᵥ=1, and therefore there should be a larger estimate for the likelihood ratio.

Assume that our estimate for the infinity likelihood ratio is “c” times larger than any calculated likelihood ratio:

$$\hat{LR} = c \frac{af}{g - f} > {LR}_{Max \vert g , f , a}$$

$$g > f > 0$$

$$a > 0$$

$$c \geq 1$$

The integer “c” may be arbitrary, but at a minimum it may be set so that the value of the estimated likelihood ratio is not less than 1.

$$\hat{LR} = \{ \begin{matrix}a & if g > 2 f \\ \frac{af}{g - f} & if g \leq 2 f\end{matrix} \\ c = \{ \begin{matrix}\frac{g - f}{f} & if g > 2 f \\ 1 & if g \leq 2 f\end{matrix}$$

For the example in the table in FIG. 11, the calculated likelihood ratio may be infinity, since 900 is greater than 200 the condition g>2f is met, the parameter c may be estimated by:

$$c = \frac{g - f}{f} = 9$$

The maximum likelihood ratio that may be calculated with the parameters in FIG. 11 may be:

$$L {R}_{Max \vert g , f , a} = \frac{3 \times 100}{1000 - 100} = .33$$

The estimated likelihood ratio may be:

[symbol]

=3

Note that the estimated likelihood ratio reaches the same conclusion as an infinity likelihood ratio; in both cases the phrase is indicative of a complaint.

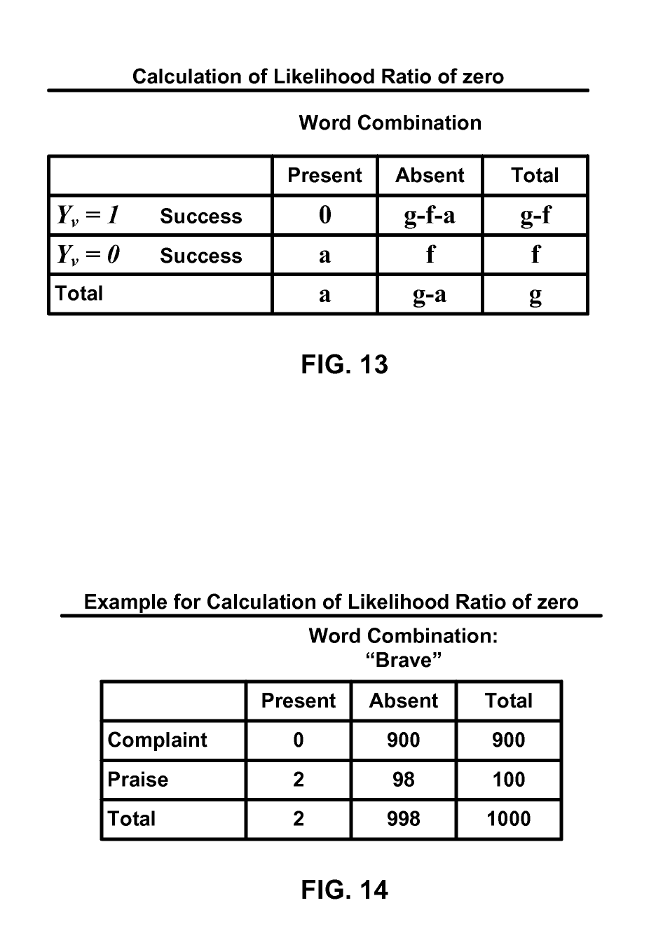

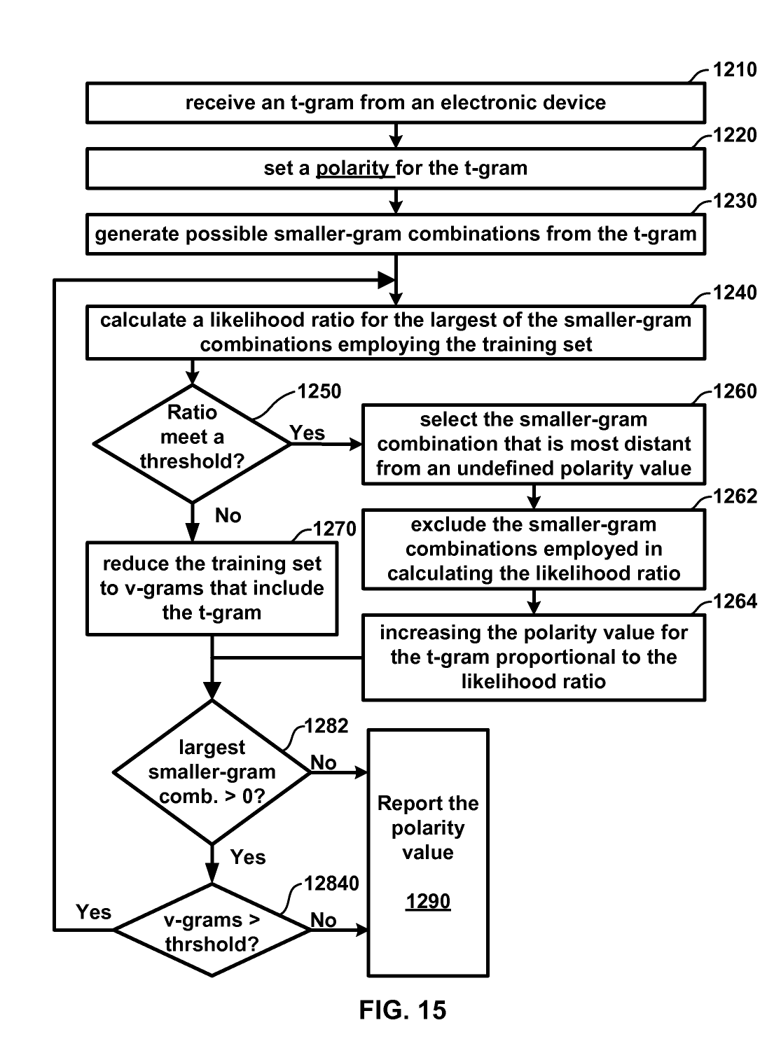

For the situation where the likelihood ratio is calculated to be zero, there may be a situation shown in the table in FIG. 13.

The likelihood ratio associated with the word combination is calculated as follows:

$$L R = \frac{\frac{0}{g - f}}{\frac{α}{f}} = \frac{0}{α} \times \frac{f}{g - f} = 0$$

$$g > f > 0$$

$$α > 0$$

$$L R = \frac{\frac{x}{g - f}}{\frac{a - x}{f}} = ( \frac{x}{α - x} ) \times \frac{f}{g - f} > \frac{x}{a} \times \frac{f}{g - f}$$

$$x = 1 , 2 , … , α$$

$$\hat{LR} = {LR}_{Min \vert g , f , α} = \frac{f}{α ( g - f )}$$

$$g > f > 0$$

$$α > 0$$

$$\hat{LR} = \{ \begin{matrix}\frac{1}{a} & if g > 2 f \\ \frac{f}{α ( g - f )} & if g \leq 2 f\end{matrix} \\ c = \{ \begin{matrix}\frac{g - f}{f} & if g > 2 f \\ 1 & if g \leq 2 f\end{matrix}$$

The table in FIG. 14 shows an example of a word combination with the likelihood calculated to be zero.

$$L R = \frac{\frac{0}{g - f}}{\frac{α}{f}} = \frac{0}{2} \times \frac{100}{900} = 0$$

$$g > f > 0$$

$$α > 0$$

$$\hat{LR} = {LR}_{Min \vert g , f , α} = \frac{100}{2 ( 1000 - 100 )}$$

$$g > f > 0$$

$$α > 0$$

$$\hat{LR} = \frac{1}{2} \\ c = 9 since 900 > 200$$

Under an assumption of independence, the words “brave” and “stupid” in the sentence “The doctor was brave but stupid” may be analyzed as:

$$\hat{LR} = \frac{1}{2} \times 3 = 1.5$$

This likelihood ratio suggests the sentence is a complaint. Note that the method of estimating the infinity and zero likelihood ratios provides a calculus for processing contradictory extreme likelihood ratios.

Processes for Classifying the Polarity of Text

The following shows how a process according to some of the various embodiments may for predicting the classification or polarity of text, referred in the following as the index case. The process refers to a likelihood ratio and minimum required replications, which are defined above. The actions in the process may include:
1. Setting process parameters. Set the posterior odd of the index text to 1. Calculate “t”, the number of words in the index text.
2. Examining consecutive word combinations of length “t”, where the words are no more than “r” words apart (typically r=1). An example is shown in block 430 of FIG. 4.
3. Calculating the minimum replication requirement needed for each word combination. An example is shown in block 440 of FIG. 4. This is also further shown in example FIG. 5.
4. If the number of cases matched to any of the word combinations exceeds the replication requirement, the process may go to action 6.
5. Set t=t−1. If t=0 stop; otherwise go to action 2.
6. Calculating the likelihood ratio associated with each word combination of length “t” that has met the minimum required replication. An example is shown in block 470 of FIG. 4. It is also shown in blocks 620 and 630 of example FIG. 6.
7. Selecting the word combination with the likelihood ratio most different from one. An example is shown in block 640 of FIG. 6.
8. Calculating the posterior odds of the index text as the product of the current value of the posterior odds of the index text times the likelihood ratio associated with the selected word combination.
9. Excluding all words that overlap with the selected word combination. This is shown in position 750 of FIG. 6.
10. Going to action 7 if any word combinations remain, otherwise going to action 5.

Note that this process may be computationally efficient as it does not necessarily examine all possible word combinations within the database but only word combinations within the index text. Also, word combinations of a common length may be evaluated simultaneously, reducing the frequency of time-consuming calls to the database. Furthermore, as one word combination may be selected, the number of words remaining in the index text may be reduced and the number of shorter length word combinations may be further reduced. These steps may allow the execution of the process in real time, with little noticeable delay by a user.

The implication of this process may be seen in an example analysis of the sentence: “I was not happy” using the database in FIG. 7. The word happy occurs often; it occurs 10 times:9 times in praises and once in a complaint. The likelihood ratio associated with the word “happy” in this data set is (1/1)/(9/9)=0.11. This likelihood ratio shows that the word “happy” is indicative of praise. The words “not happy” occur only once in the database. It only occurs in a complaint and does not occur in any praises. Therefore, the likelihood ratio is (1/1)/(0/9), which, based on the “Procedure for estimating extreme likelihood ratios”, may be estimated as one plus the number of times the word combination repeats in the database. The likelihood ratio may then be estimated as (1/1)/(0/9)˜2.

In an example analysis of the sentence “I was not happy”, the process may start with the longest possible word combination, t=4, the complete sentence. This sentence is not present in the database and therefore the replication requirement is not met. The algorithm then reduces “t.” Now the process may evaluate word combinations of length 3. These include “was not happy”, “I not happy”, “I was happy” and “I was not.” None of these occur in the database. The process further reduces “t” and evaluates word combinations of length 2: “I was”, “I not”, etc. Among these word combinations, the only combination that occurs in the database is “not happy”. This combination occurs once. The number of replications needed for this word combination to be accepted is the minimum of 10*0.01*0.09=0.009 (the number of cases with the combination expected by chance) and 96 (the number of cases needed for sufficient power). Therefore, k=0.009 and the single case that has been observed is sufficient replication to proceed. The words “not happy” are selected and deleted from further consideration. Because “not happy” has a likelihood ratio of 2, the posterior odd of the index text is increased to 2 using the Bayes formula. The words “I” and “was” still remain. The algorithm now continues with t=1. The only possible words are “I” and “was”. These words do not occur in the database and therefore do not meet the replication requirement. “t” is further reduced and is now zero; the process ends. The net result of the algorithm has been that with odds of 2 to 1, the sentence “I was not happy” is a complaint. Note that the process did not pick the single word “happy”; if it had done so, it would have arrived at the wrong conclusion. Note also that the word “happy” was analyzed in the context of preceding words that had negated its meaning. This example demonstrates the efficiency of the process in learning the context in which a word is used. In this case, the process was able to learn the context of the word “happy” from one case.

Process for Extraction of Word Combination

The example process presented in the previous section produces the odds for classifying the polarity of a sentence or free text. The same example process, in action 7, also identifies word combinations (context of a word) that were influential in making this prediction. Non-probabilistic processes refer to the identification of these word combinations as lexicon extraction. In the present invention, the use of a word combination by the process is the method of identifying the word combination. The likelihood associated with the word combination sets its polarity. Word combinations with likelihood ratios larger than two strongly support the Y=1 prediction. Word combinations with likelihood ratio less than one half strongly support the reverse. One may consider likelihood ratios between 2 and ½ as not strong support for either conclusion.

Some of the various embodiments include a text clustering/polarity setting system, comprised of the combination of (a) Bayesian probability model, and (2) k Nearest Neighbor case-based reasoning. The system may be optimized so that both approaches arrive at the same conclusion. The minimum replication requirement of k Nearest Neighbor method may be used to identify context dependent words within the Bayes probability model.

The minimum replication requirements may be different for word combinations of different length. These minima may be set based on the frequency of the words within the word combination, the size of the training set and the power parameters set by the user.

The extreme likelihood ratios (division or uncalculated-able multiplication by zero) may be replaced with the maximum calculate-able likelihood ratio in the training set.

Some of the various embodiments include a process for identifying context dependence among words within a text, through identifying the longest informative combinations of words that are unlikely to occur randomly.

Some of the various embodiments include a process for identifying subgroups within data, where word combinations repeat frequently.

Some of the various embodiments include a process for making sentiment predictions useful in real time performance evaluations through examining time to or events until next negative sentiment. This process may employ text clustering/polarity setting system results to monitor in real time the number of customers served until receiving next case of negative polarity.

FIG. 12 is a flow diagram of an example process to detect a sentiment from a t-gram as per an aspect of an embodiment of the present invention. The flow diagram, or aspects thereof, may be implemented as a non-transitory tangible computer readable media containing one or more instructions executable by one or more processors.

At 1210 a t-gram may be received by the one or more processors from an electronic device. The one or more processors may operate in a device such as a server, a computer, a mobile device, a combination thereof, and/or the like. The t-gram may be received from the electronic device over a network such as the Internet, an intranet, a combination thereof, and/or the like. The electronic device may providing the one or more processors may be: a tablet, a computer, a cell phone, a mobile computing device, a server, a combination thereof, and/or the like.

The t-gram may comprise one or more grams. Each of the one or more grams may represent a word in a collection of words. A word may be at least one of the following: a representation of an element in a spoken language, a representation of an element in a written language, a representation of an element in a computer language, a representation of biological element in a series of biological elements, a nucleotide in a strand of DNA, an event in a series of consecutive events, a combination thereof, and/or the like. In some cases, the words may be in an audio form with spoken words separated by pauses. These oral words may be captured by an electronic recording device. A program may be used to convert the audio into text t-grams. An example of such a program is Dragon Naturally speaking by Nuance Communications, Inc. of Burlington, Mass.

The polarity of the t-gram may be set at 1220, for example, to a value of one. A negative polarity may correspond to at least one of the following: a negative sentiment, a complaint, an absence of an event, the absence of a matched word in a dictionary, a combination thereof, and/or the like. A positive polarity may correspond to at least one of the following: a positive sentiment, a compliment, the presence of an event, a matched word in a dictionary, a combination thereof, and/or the like.

According to some of the various embodiments, smaller-gram combinations from the t-gram may be generated at 1230. This may, for example in some embodiments, include generating all possible smaller-gram combinations from the t-gram. In some other embodiments, this may include generating possible smaller-gram combinations from the t-gram in the order of size. For example, from small to large, or large to small. In yet other embodiments, the generating possible smaller-gram combinations from the t-gram may further includes generating possible smaller-gram combinations employing consecutive grams in the t-gram. Additionally, some of the embodiments may include generating possible smaller-gram combinations employing non-consecutive grams in the t-gram comprising consecutive grams with at least one skipped gram.

A likelihood ratio for the largest of the smaller-gram combinations employing the training set may be calculated at 1240. According to some of the various embodiments, the likelihood ratio may be the prevalence of the t-gram in a positive polarity in a training set divided by the prevalence of the t-gram in a negative polarity in a training set. The training set may comprise a set of v-grams with known polarities, and/or the training set comprises a set of v-grams with different sizes m. According to some of the various embodiments, when the likelihood ratio of the t-gram may be zero or infinity, the likelihood ratio may be alternatively calculated based on at least one of the following: the size of a training set; and the number of times the t-gram is classified with a negative polarity.

A determination of whether the likelihood ratio meets a minimum replication threshold may be performed at 1250. The minimum replication threshold may be the maximum of the expected number of t-grams that may be randomly observed based on the independent occurrence of each gram, and the number of v-grams in the training set needed to detect a significant difference between the observed occurrence of the t-gram and an uncertainty value. According to some of the various embodiments, this determining may include calculating the expected number of t-grams that may be randomly observed based on the independent occurrence of each gram. According to some of the various embodiments, this determination may include calculating the number of v-grams in the training set needed to detect a significant difference between the observed occurrence of the t-gram and an uncertainty value. The uncertainty value may be 0.5.

If the minimum replication threshold is satisfied, a series of actions may be taken by the one or more processors. The smaller-gram combination that is most distant from an undefined polarity value may be selected at 1260. The undefined polarity value may be one. At 1262, the smaller-gram combinations employed in calculating the likelihood ratio may be excluded. The polarity value for the t-gram proportional to the likelihood ratio may be increased at 1264. The training set may be reduced to v-grams that include the current t-gram.

If the minimum replication threshold is not satisfied, the size of the t-gram may be reduced by 1.

If two conditions are met, the process run through another iteration. At 1282, a determination may be made as to whether the largest of the smaller-gram combinations is larger than zero and at 1284 a determination of whether the number of v-grams in a training set is above a threshold. If either determination is negative, the polarity value may be reported via the electronic device at 1290 and the current process completed. Otherwise, the process may iterate again starting at 1240.

According to some of the various embodiments, real time performance evaluations may be performed through examining time to or events until next negative polarity. This provides a capability of analyzing sentiment real-time without having to wait until after a larger set of t-grams are collected.

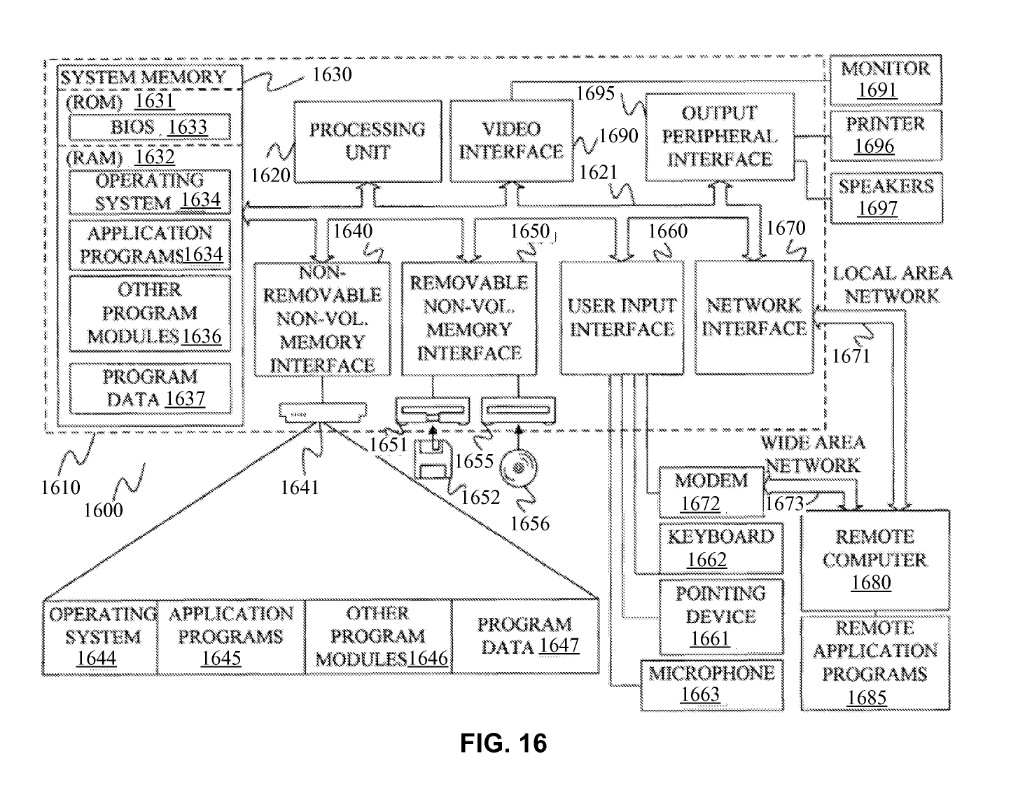

FIG. 16 illustrates an example of a suitable computing system environment 1600 on which embodiments may be implemented. The computing system environment 1600 is only one example of a suitable computing environment and is not intended to suggest any limitation as to the scope of use or functionality of the claimed subject matter. Neither should the computing environment 1600 be interpreted as having any dependency or requirement relating to any one or combination of components illustrated in the exemplary operating environment 1600.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 16, an example system for implementing some embodiments includes a general-purpose computing device in the form of a computer 1610. Components of computer 1610 may include, but are not limited to, a processing unit 1620, a system memory 1630, and a system bus 1621 that couples various system components including the system memory to the processing unit 1620.

Computer 1610 typically includes a variety of computer readable media. Computer readable media can be any available media that can be accessed by computer 1610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 1630 includes computer storage media in the form of volatile and/or nonvolatile memory such as read only memory (ROM) 1631 and random access memory (RAM) 1632. A basic input/output system 1633 (BIOS), containing the basic routines that help to transfer information between elements within computer 1610, such as during start-up, is typically stored in ROM 1631. RAM 1632 typically contains data and/or program modules that are immediately accessible to and/or presently being operated on by processing unit 1620. By way of example, and not limitation, FIG. 16 illustrates operating system 1634, application programs 1635, other program modules 1636, and program data 1637.

The computer 1610 may also include other removable/non-removable volatile/nonvolatile computer storage media. By way of example only, FIG. 16 illustrates a hard disk drive 1641 that reads from or writes to non-removable, nonvolatile magnetic media, a magnetic disk drive 1651 that reads from or writes to a removable, nonvolatile magnetic disk 1652, and an optical disk drive 1655 that reads from or writes to a removable, nonvolatile optical disk 1656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1641 is typically connected to the system bus 1621 through a non-removable memory interface such as interface 1640, and magnetic disk drive 1651 and optical disk drive 1655 are typically connected to the system bus 1621 by a removable memory interface, such as interface 1650.

The drives and their associated computer storage media discussed above and illustrated in FIG. 16, provide storage of computer readable instructions, data structures, program modules and other data for the computer 1610. In FIG. 16, for example, hard disk drive 1641 is illustrated as storing operating system 1644, position-dependent phonetic language model 212 and decoder 312.

A user may enter commands and information into the computer 1610 through input devices such as a keyboard 1662, a microphone 1663, and a pointing device 1661, such as a mouse, trackball or touch pad. These and other input devices are often connected to the processing unit 1620 through a user input interface 1660 that is coupled to the system bus, but may be connected by other interface and bus structures, such as a parallel port, game port or a universal serial bus (USB). A monitor 1691 or other type of display device is also connected to the system bus 1621 via an interface, such as a video interface 1690.

The computer 1610 is operated in a networked environment using logical connections to one or more remote computers, such as a remote computer 1680. The remote computer 1680 may be a personal computer, a hand-held device, a server, a router, a network PC, a peer device or other common network node, and typically includes many or all of the elements described above relative to the computer 1610. The logical connections depicted in FIG. 16 include a local area network (LAN) 1671 and a wide area network (WAN) 1673, but may also include other networks. Such networking environments are commonplace in offices, enterprise-wide computer networks, intranets and the Internet.

When used in a LAN networking environment, the computer 1610 is connected to the LAN 1671 through a network interface or adapter 1670. When used in a WAN networking environment, the computer 1610 typically includes a modem 1672 or other means for establishing communications over the WAN 1673, such as the Internet. The modem 1672, which may be internal or external, may be connected to the system bus 1621 via the user input interface 1660, or other appropriate mechanism. In a networked environment, program modules depicted relative to the computer 1610, or portions thereof, may be stored in the remote memory storage device. By way of example, and not limitation, FIG. 16 illustrates remote application programs 1685 as residing on remote computer 1680. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In this specification, “a” and “an” and similar phrases are to be interpreted as “at least one” and “one or more.” References to “an” embodiment in this disclosure are not necessarily to the same embodiment.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (i.e hardware with a biological element) or a combination thereof, all of which are behaviorally equivalent. For example, modules may be implemented using computer hardware in combination with software routine(s) written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies may be used in combination to achieve the result of a functional module.

Some embodiments may employ processing hardware. Processing hardware may include one or more processors, computer equipment, embedded system, machines and/or the like. The processing hardware may be configured to execute instructions. The instructions may be stored on a machine-readable medium. According to some embodiments, the machine-readable medium (e.g. automated data medium) may be a medium configured to store data in a machine-readable format that may be accessed by an automated sensing device. Examples of machine-readable media include: magnetic disks, cards, tapes, and drums, punched cards and paper tapes, optical disks, barcodes, magnetic ink characters and/or the like.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) of patient comments. However, one skilled in the art will recognize that embodiments of the invention could be used to analyze any text including: reviews, letters, emails, customer comments, processing of natural language in transcriptions, combination thereof, and/or the like.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A non-transitory tangible computer readable media containing one or more instructions executable by one or more processors to perform the method comprising:
a. receiving a t-gram from an electronic device, the t-gram comprising one or more grams, each of the one or more grams representing a word in a collection of words;
b. setting a polarity for the t-gram;
c. generating possible smaller-gram combinations from the t-gram;
d. iteratively, while the largest of the smaller-gram combinations is larger than zero and the number of v-grams in a training set is above a threshold:
i. calculating a likelihood ratio for the largest of the smaller-gram combinations employing the training set; and
ii. determining if the likelihood ratio meets a minimum replication threshold;
1. if the minimum replication threshold is satisfied:
a. selecting the smaller-gram combinations that is most distant from an undefined polarity value;
b. excluding the smaller-gram combinations employed in calculating the likelihood ratio;
c. increasing the polarity value for the t-gram proportional to the likelihood ratio; and
d. reducing the training set to v-grams that include the t-gram; and
2. if the minimum replication threshold is not satisfied, reducing the size of the smaller-gram by 1; and
e. reporting, via the electronic device, the polarity value.

2. The media according to claim 1, wherein a negative polarity corresponds to at least one of the following:
a. a negative sentiment;
b. a complaint;
c. an absence of an event; and
d. absence of a matched word in a dictionary.

3. The media according to claim 1, wherein a positive polarity corresponds to at least one of the following:
a. a positive sentiment;
b. a compliment;
c. an presence of an event; and
d. a matched word in a dictionary.

4. The media according to claim 1, wherein the likelihood ratio is the prevalence of the t-gram in a positive polarity in a training set divided by the prevalence of the t-gram in a negative polarity in a training set.

5. The media according to claim 1, wherein the likelihood ratio of the t-gram is zero or infinity, the likelihood ratio is calculated based on at least one of the following:
a. the size of a training set; and
b. the number of times the t-gram is classified with a negative polarity.

6. The media according to claim 1, wherein the training set comprises a set of v-grams with known polarities.

7. The media according to claim 1, wherein the training set comprises a set of v-grams with different sizes m.

8. The media according to claim 1, wherein the undefined polarity value is one.

9. The media according to claim 1, wherein the generating possible smaller-gram combinations from the t-gram further includes generating all possible smaller-gram combinations from the t-gram.

10. The media according to claim 1, wherein the generating possible smaller-gram combinations from the t-gram further includes generating possible smaller-gram combinations from the t-gram in the order of size.

11. The media according to claim 1, wherein the generating possible smaller-gram combinations from the t-gram further includes generating possible smaller-gram combinations employing consecutive grams in the t-gram.

12. The media according to claim 1, wherein the generating possible smaller-gram combinations from the t-gram further includes generating possible smaller-gram combinations employing non-consecutive grams in the t-gram comprising consecutive grams with at least one skipped gram.

13. The media according to claim 1, further including setting a minimum replication threshold as the maximum of:
a. the expected number of t-grams that can be randomly observed based on the independent occurrence of each gram; and
b. the number of v-grams in the training set needed to detect a significant difference between the observed occurrence of the t-gram and an uncertainty value.

14. The media according to claim 1, wherein the determining if the t-gram meets a minimum replication threshold comprises calculating the expected number of t-grams that can be randomly observed based on the independent occurrence of each gram.

15. The media according to claim 1, wherein the determining if the t-gram meets a minimum replication threshold comprises calculating the number of v-grams in the training set needed to detect a significant difference between the observed occurrence of the t-gram and an uncertainty value.

16. The media according to claim 15, wherein the uncertainty value if 0.5.

17. The media according to claim 1, wherein the electronic device is one of the following:
a. a tablet;
b. a computer;
c. a cell phone;
d. a mobile computing device; and
e. a server.

18. The media according to claim 1, wherein the setting the polarity of the collection of t-grams includes setting a polarity variable to 1.

19. The media according to claim 1, further comprising performing real time performance evaluations through examining time to or events until next negative polarity.

20. The media according to claim 1, wherein the word is one of the following:
a. a representation of an element in a spoken language;
b. a representation of an element in a written language;
c. a representation of an element in a computer language;
d. a representation of biological element in a series of biological elements;
e. a nucleotide in a strand of DNA; and
f. an event in a series of consecutive events.

21. The media according to claim 1, further comprising converting an audio t-gram recorded using an electronic recording device comprising spoken words separated by pauses to a text t-gram.
